(19) United States
(12) Patent Application Publication
(10) Pub. No.: US 2024/0303500 A1
(43) Pub. Date: Sep. 12, 2024

(54) SERVER AND AGENT FOR REPORTING OF COMPUTATIONAL RESULTS DURING AN ITERATIVE LEARNING PROCESS

(71) Applicant: Telefonaktiebolaget LM Ericsson (publ), Stockholm (SE)

(72) Inventors: Erik G. Larsson, Linköping (SE); Reza Moosavi, Linköping (SE); Henrik Rydén, Stockholm (SE)

(21) Appl. No.: 18/573,124

(22) PCT Filed: Jul. 6, 2021
(86) PCT No.: PCT/EP2021/068626

§ 371 Date: Dec. 21, 2023

(51) Int. Cl. G06N 3/092; G06N 3/0455

(52) U.S. Cl. CPC G06N 3/092; G06N 3/0455

(57) ABSTRACT

There is provided mechanisms for configuring agent entities with a reporting schedule for reporting computational results during an iterative learning process. A method is performed by a server entity. The method comprises configuring the agent entities with a computational task and a reporting schedule. The reporting schedule defines an order according to which the agent entities are to report computational results of the computational task. The agent entities are configured to, per each iteration of the learning process, base their computation of the computational task on any computational result of the computational task received from any other of the agent entities prior to when the agent entities themselves are scheduled to report their own computational results for that iteration. The method comprises performing the iterative learning process with the agent entities according to the reporting schedule and until a termination criterion is met.

### TECHNICAL FIELD

Embodiments presented herein relate to a method, a server entity, a computer program, and a computer program product for configuring agent entities with a reporting schedule for reporting computational results during an iterative learning process. Embodiments presented herein further relate to a method, an agent entity, a computer program, and a computer program product for being configured by a server entity with a reporting condition for reporting computational results during an iterative learning process.

### BACKGROUND

The increasing concerns for data privacy have motivated the consideration of collaborative machine learning systems with decentralized data where pieces of training data are stored and processed locally by edge user devices, such as user equipment. Federated learning (FL) is one non-limiting example of a decentralized learning topology, where multiple (possible very large number of) agents, for example implemented in user equipment, participate in training a shared global learning model by exchanging model updates with a centralized parameter server (PS), for example implemented in a network node.

FL is an iterative process where each global iteration, often referred to as communication round, is divided into three phases: In a first phase the PS broadcasts the current model parameter vector to all participating agents. In a second phase each of the agents performs one or several steps of a stochastic gradient descent (SGD) procedure on its own training data based on the current model parameter vector and obtains a model update. In a third phase the model updates from all agents are sent to the PS, which aggregates the received model updates and updates the parameter vector for the next iteration based on the model updates according to some aggregation rule. The first phase is then entered again but with the updated parameter vector as the current model parameter vector.

A common baseline scheme in FL is named Federated SGD, where in each local iteration, only one step of SGD is performed at each participating agent, and the model updates contain the gradient information. A natural extension is so-called Federated Averaging, where the model updates from the agents contain the updated parameter vector after performing their local iterations.

All participating agents have to wait until the next model parameter vector is broadcasted before performing one or several steps of the SGD procedure on its own training data based on the new model parameter vector. This introduces a delay, or latency, in the iterative process, thus making federated learning in its nominal form inefficient.

### SUMMARY

An object of embodiments herein is to address the above issues in order to enable efficient communication between the PS (hereinafter denoted server entity) and the agents (hereinafter denoted agent entities) whilst reducing the reporting latency from the agents to the PS.

According to a first aspect there is presented a method for configuring agent entities with a reporting schedule for reporting computational results during an iterative learning process. The method is performed by a server entity. The method comprises configuring the agent entities with a computational task and a reporting schedule. The reporting schedule defines an order according to which the agent entities are to report computational results of the computational task. The agent entities are configured to, per each iteration of the learning process, base their computation of the computational task on any computational result of the computational task received from any other of the agent entities prior to when the agent entities themselves are scheduled to report their own computational results for that iteration. The method comprises performing the iterative learning process with the agent entities according to the reporting schedule and until a termination criterion is met.

According to a second aspect there is presented a server entity for configuring agent entities with a reporting schedule for reporting computational results during an iterative learning process. The server entity comprises processing circuitry. The processing circuitry is configured to cause the server entity to configure the agent entities with a computational task and a reporting schedule. The reporting schedule defines an order according to which the agent entities are to report computational results of the computational task. The agent entities are configured to, per each iteration of the learning process, base their computation of the computational task on any computational result of the computational task received from any other of the agent entities prior to when the agent entities themselves are scheduled to report their own computational results for that iteration. The processing circuitry is configured to cause the server entity to perform the iterative learning process with the agent entities according to the reporting schedule and until a termination criterion is met.

According to a third aspect there is presented a server entity for configuring agent entities with a reporting schedule for reporting computational results during an iterative learning process. The server entity comprises a configure module configured to configure the agent entities with a computational task and a reporting schedule. The reporting schedule defines an order according to which the agent entities are to report computational results of the computational task. The agent entities are configured to, per each iteration of the learning process, base their computation of the computational task on any computational result of the computational task received from any other of the agent entities prior to when the agent entities themselves are scheduled to report their own computational results for that iteration. The server entity comprises a process module configured to perform the iterative learning process with the agent entities according to the reporting schedule and until a termination criterion is met.

According to a fourth aspect there is presented a computer program for configuring agent entities with a reporting schedule for reporting computational results during an iterative learning process, the computer program comprising computer program code which, when run on processing circuitry of a server entity, causes the server entity to perform a method according to the first aspect.

According to a fifth aspect there is presented a method for is configured by a server entity with a reporting condition for reporting computational results during an iterative learning process. The method is performed by an agent entity. The method comprises obtaining configuring in terms of a computational task and a reporting condition from the server entity. The reporting schedule defines an order according to which agent entities are to report computational results of the computational task. The agent entity is configured to, per each iteration of the learning process, base its computation of the computational task on any computational result of the computational task received from any other agent entity prior to when the agent entity itself is scheduled to report its own computational result for that iteration. The method comprises performing the iterative learning process with the server entity until a termination criterion is met. As part of the iterative learning process, the agent entity reports a computational result for an iteration of the learning process according to the reporting schedule.

According to a sixth aspect there is presented an agent entity for is configured by a server entity with a reporting condition for reporting computational results during an iterative learning process. The agent entity comprises processing circuitry. The processing circuitry is configured to cause the agent entity to obtain configuring in terms of a computational task and a reporting condition from the server entity. The reporting schedule defines an order according to which agent entities are to report computational results of the computational task. The agent entity is configured to, per each iteration of the learning process, base its computation of the computational task on any computational result of the computational task received from any other agent entity prior to when the agent entity itself is scheduled to report its own computational result for that iteration. The processing circuitry is configured to cause the agent entity to perform the iterative learning process with the server entity until a termination criterion is met. As part of the iterative learning process, the agent entity reports a computational result for an iteration of the learning process according to the reporting schedule.

According to a seventh aspect there is presented an agent entity for is configured by a server entity with a reporting condition for reporting computational results during an iterative learning process. The agent entity comprises an obtain module configured obtain configuring in terms of a computational task and a reporting condition from the server entity. The reporting schedule defines an order according to which agent entities are to report computational results of the computational task. The agent entity is configured to, per each iteration of the learning process, base its computation of the computational task on any computational result of the computational task received from any other agent entity prior to when the agent entity itself is scheduled to report its own computational result for that iteration. The agent entity comprises a process module configured to perform the iterative learning process with the server entity until a termination criterion is met. As part of the iterative learning process, the agent entity reports a computational result for an iteration of the learning process according to the reporting schedule.

According to an eighth aspect there is presented a computer program for an agent entity to be configured by a server entity with a reporting condition for reporting computational results during an iterative learning process, the computer program comprising computer program code which, when run on processing circuitry of an agent entity, causes the agent entity to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these methods, these server entities, these agent entities, these computer programs, and this computer program product provide efficient communication between the server entity and the agent entities whilst reducing the reporting latency from the agent entities to the server.

Advantageously, these methods, these server entities, these agent entities, these computer programs, and this computer program product enable the delay, or latency, in the iterative process to be avoided, thus making the federated learning efficient.

Advantageously, these methods, these server entities, these agent entities, these computer programs, and this computer program product enable faster convergence of the iterative learning process. This is due to the fact that some of the agent entities use an intermediate model update by overhearing the transmission of other agent entities. This, consequently, will results in fewer number of iterations being performed that. In turn, this saves part of the over-the-air signaling between the agent entities and the server entity.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a signalling diagram according to an example;

FIGS. 3 and 4 are flowcharts of methods according to embodiments;

FIG. 5 is a signalling diagram according to an embodiment;

FIGS. 6 and 7 show simulation results according to embodiments;

FIG. 8 is a schematic illustration of a CSI compression process according to an embodiment;

FIG. 9 is a schematic diagram showing functional units of a server entity according to an embodiment;

FIG. 10 is a schematic diagram showing functional modules of a server entity according to an embodiment;

FIG. 11 is a schematic diagram showing functional units of an agent entity according to an embodiment;

FIG. 12 is a schematic diagram showing functional modules of an agent entity according to an embodiment; and

FIG. 13 shows one example of a computer program product comprising computer readable means according to an embodiment;

FIG. 14 is a schematic diagram illustrating a telecommunication network connected via an intermediate network to a host computer in accordance with some embodiments; and

FIG. 15 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

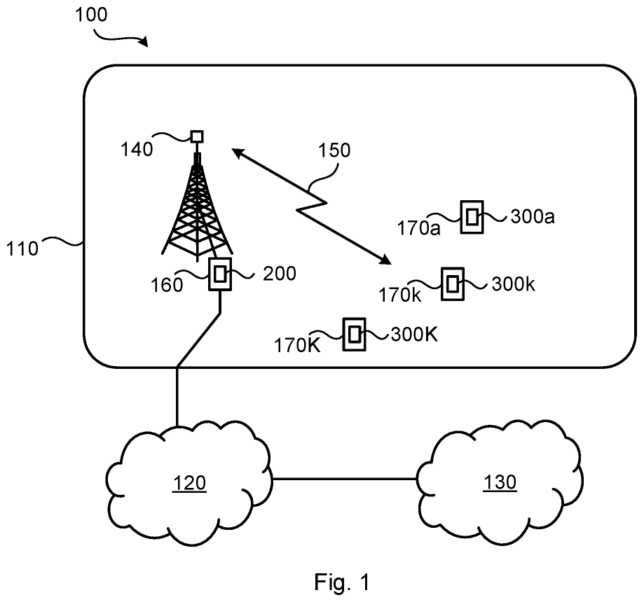

FIG. 1 is a schematic diagram illustrating a communication network 100 where embodiments presented herein can be applied. The communication network 100 could be a third generation (3G) telecommunications network, a fourth generation (4G) telecommunications network, a fifth (5G) telecommunications network, a sixth (6G) telecommunications network, and support any 3GPP telecommunications standard.

The communication network 100 comprises a transmission and reception point 140 configured to provide network access to user equipment 170a, 170k, 170K in an (radio) access network 110 over a radio propagation channel 150. The access network 110 is operatively connected to a core network 120. The core network 120 is in turn operatively connected to a service network 130, such as the Internet. The user equipment 170a:170K is thereby, via the transmission and reception point 140, enabled to access services of, and exchange data with, the service network 130.

Operation of the transmission and reception point 140 is controlled by a controller 160. The controller 160 might be part of, collocated with, or integrated with the transmission and reception point 140.

Examples of network nodes 160 are (radio) access network nodes, radio base stations, base transceiver stations, Node Bs (NBs), evolved Node Bs (eNBs), gNBs, access points, access nodes, and integrated access and backhaul nodes. Examples of user equipment 170a:170K are wireless devices, mobile stations, mobile phones, handsets, wireless local loop phones, smartphones, laptop computers, tablet computers, network equipped sensors, network equipped vehicles, and so-called Internet of Things devices.

It is assumed that the user equipment 170a:170K are to be utilized during an iterative learning process and that the user equipment 170a:170K as part of performing the iterative learning process are to report computational results to the network node 160. The network node 160 therefore comprises, is collocated with, or integrated with, a server entity 200. Each of the user equipment 170a:170K comprises, is collocated with, or integrated with, a respective agent entity 300a:300K.

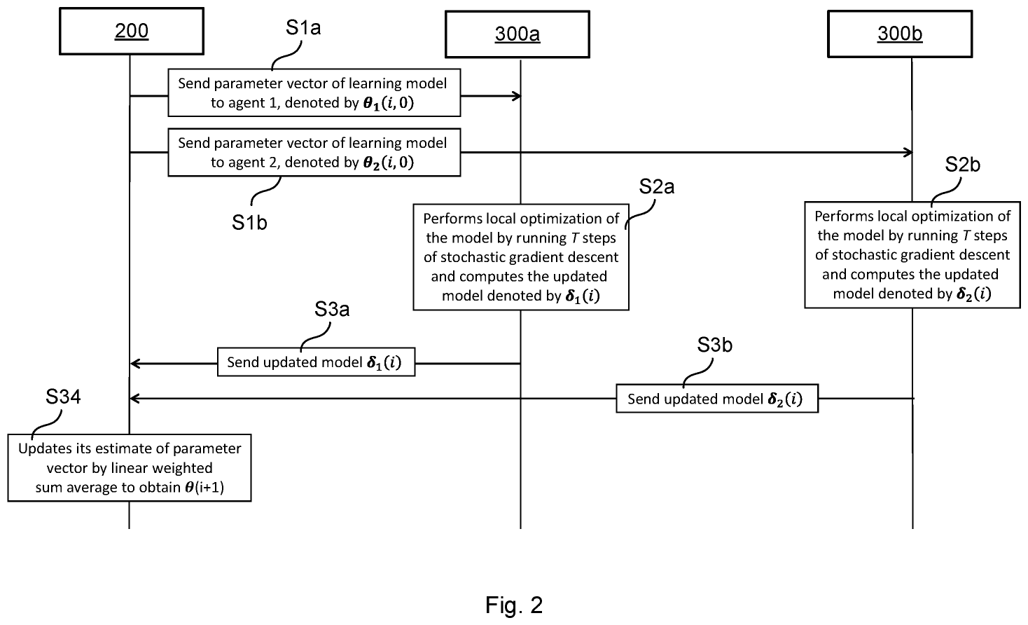

As disclosed above, the agent entities 300a:300K have to wait until the next model parameter vector is broadcasted before performing one or several steps of the SGD procedure on its own training data based on the new model parameter vector. This introduces a delay, or latency, in the iterative process, thus making federated learning in its nominal form inefficient. To illustrate this further, reference is next made to the signalling diagram of FIG. 2, illustrating an examples of a nominal iterative learning process. For simplicity, but without loss of generality, the example is shown for two agent entities 300a, 300b, but the principles hold also for larger number of agent entities 300a:300K.

The server entity 200 updates its estimate of the learning model, as defined by a parameter vector θ(i), by performing global iterations with an iteration time index i. At each iteration i, the following steps are performed:

Steps S1a, S1b: The server entity 200 broadcasts the parameter vector of the learning model, θ(i), to the agent entities 300a, 300b.

Steps S2a, S2b: Each agent entity 300a, 300b performs a local optimization of the model by running T steps of a stochastic gradient descent update on θ(i), based on its local training data;

$${θ}_{k} ( i , τ ) = {θ}_{k} ( i , τ - 1 ) - {η}_{k} ∇ {f}_{k} ( {θ}_{k} ( i , τ - 1 ) ) \qquad τ = 1 , … , T ,$$

where ηₖ is a weight and ƒₖ is the objective function used at agent entity k (and which is based on its locally available training data).

Steps S3a, S3b: Each agent entity 300a, 300b transmits to the server entity 200 their model update δₖ (i);

$${δ}_{k} ( i ) = {θ}_{k} ( i , T ) - {θ}_{k} ( i , 0 ) ,$$

where θₖ (i, 0) is the model that agent entity k received from the server entity 200. Steps S3a, S3b may be performed sequentially, in any order, or simultaneously.

Step S4: The server entity 200 updates its estimate of the parameter vector θ(i) by adding to it a linear combination (weighted sum) of the updates received from the agent entities 300a, 300b;

$$θ ( i + 1 ) = θ ( i ) + {w}_{1} {δ}_{1} ( i ) + {w}_{2} {δ}_{2} ( i )$$

where wₖ are weights.

Thus, the computations in steps S2a, S2b are independent of each other. That is, agent entity 300a is not aware of any computations made by agent entity 300b, and vice versa.

At least some of the herein disclosed embodiments are therefore based on that at least some of the agent entities 300a:300K can overhear the transmission of the model update δₖ(i) from at least some other agent entity 300a:300K. In this way, the agent entities 300a:300K overhearing the transmission can include the model update δₖ(i) from at least some other agent entity 300a:300K in their own calculations. This requires the agent entities 300a:300K to follow a reporting schedule when reporting their computational results during the iterative learning process.

The embodiments disclosed herein therefore in particular relate to mechanisms for configuring agent entities 300a:300K with a reporting schedule for reporting computational results during an iterative learning process and for an agent entity 300k to be configured by a server entity 200 with a reporting condition for reporting computational results during an iterative learning process. In order to obtain such mechanisms there is provided a server entity 200, a method performed by the server entity 200, a computer program product comprising code, for example in the form of a computer program, that when run on processing circuitry of the server entity 200, causes the server entity 200 to perform the method. In order to obtain such mechanisms there is further provided an agent entity 300k, a method performed by the agent entity 300k, and a computer program product comprising code, for example in the form of a computer program, that when run on processing circuitry of the agent entity 300k, causes the agent entity 300k to perform the method.

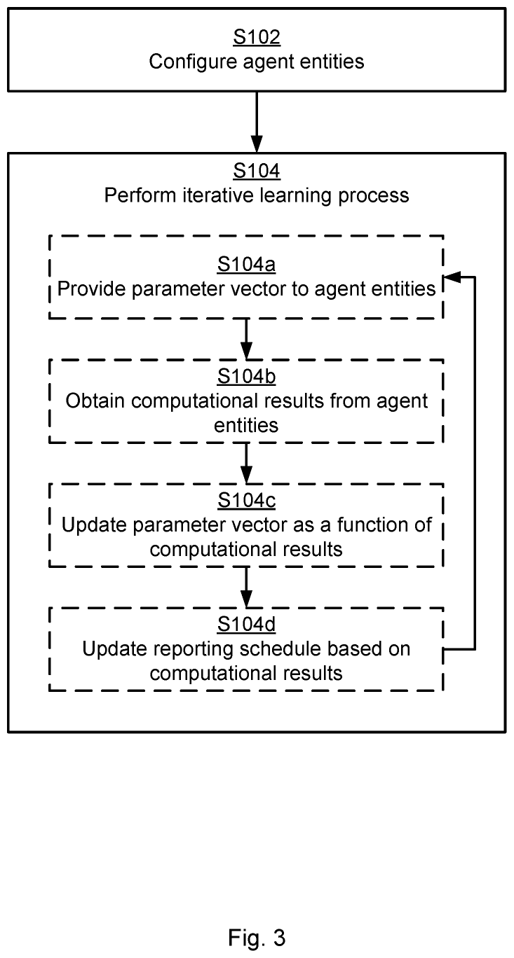

Reference is now made to FIG. 3 illustrating a method for configuring agent entities 300a:300K with a reporting schedule for reporting computational results during an iterative learning process as performed by the server entity 200 according to an embodiment.

S102: The server entity 200 configures the agent entities 300a:300K with a computational task and a reporting schedule. The reporting schedule defines an order according to which the agent entities 300a:300K are to report computational results of the computational task. The agent entities 300a:300K are configured to, per each iteration of the learning process, base their computation of the computational task on any computational result of the computational task received from any other of the agent entities 300a:300K prior to when the agent entities 300a:300K themselves are scheduled to report their own computational results for that iteration.

S104: The server entity 200 performs the iterative learning process with the agent entities 300a:300K according to the reporting schedule and until a termination criterion is met.

Embodiments relating to further details of configuring agent entities 300a:300K with a reporting schedule for reporting computational results during an iterative learning process as performed by the server entity 200 will now be disclosed.

There may be different ways in which the reporting schedule can be represented. One way to represent the reporting schedule is in terms of time-frequency resources. In particular, in some embodiments, the reporting schedule defines time-frequency resources in which each of the agent entities 300a:300K is to report its own computational result. Further, time-frequency resources can be defined for when in time (and at which frequency) each of the agent entities 300a:300K is to listen for reportings from other of the agent entities 300a:300K. In particular, in some embodiments, the reporting schedule defines time-frequency resources in which each of the agent entities 300a:300K is to receive any computational result of the computational task from any other of the agent entities 300a:300K. Further, time-frequency resources can be defined for when in time (and at which frequency) each of the agent entities 300a:300K is to report its own computational result. In particular, in some embodiments, the reporting schedule defines time-frequency resources in which each of the agent entities 300a:300K is to report its own computational result.

In some aspects, the reporting schedule defines a sequential order according to which the agent entities 300a:300K are to report their computational results. In particular, in some embodiments, according to the reporting schedule, the agent entities 300a:300K are configured to one at a time in a sequential order report their computational results of the computational task. There could be different ways to select the sequential order according to which the agent entities 300a:300K are to report their computational results. In some non-limiting examples, the sequential order is dependent on at least one of: the channel quality between the server entity 200 and each of the agent entities 300a:300K, the channel quality between the agent entities 300a:300K themselves, the geographical location of each of the agent entities 300a:300K, device information of each of the agent entities 300a:300K, device capability of each of the agent entities 300a:300K, the amount of data locally obtainable by of each of the agent entities 300a:300K. For example, agent entities 300a:300K with higher channel quality between themselves and the server entity 200 might be prioritized over agent entities 300a:300K with lower channel quality between themselves and the server entity 200. Likewise, agent entities 300a:300K with higher channel quality between themselves and other agent entities 300a:300K might be prioritized over agent entities 300a:300K with lower channel quality between themselves and other agent entities 300a:300K. For example, agent entities 300a:300K with higher amount of locally obtainable data might be prioritized over agent entities 300a:300K with lower amount of locally obtainable data. For example, in terms of device capability, agent entities 300a:300K with higher available transmission power and/or computational power might be prioritized over agent entities 300a:300K with lower available transmission power and/or computational power. The geographical location of each of the agent entities 300a:300K can be defined by a beam index, such as an SSB index (where SSB is short for synchronization signal block) or location-based services positioning or ProSe Discovery procedures (where ProSe is short for Proximity Service as available in some Long Term Evolution and New Radio networks).

There could be a large overhead in case all agent entities 300a:300K are to listen for reportings from any other of the agent entities 300a:300K. Hence, a selection can be made regarding which agent entities 300a:300K are to listen for reportings from which other of the agent entities 300a:300K. Therefore, there could be different ways to select whether or not each of the agent entities 300a:300K is to listen for reportings from any other of the agent entities 300a:300K or not. In some non-limiting examples, whether or not the agent entities 300a:300K are to be configured to base their computation of the computational task on any computational result of the computational task received from any other of the agent entities 300a:300K is dependent on at least one of: the channel quality between the agent entities 300a:300K themselves, the geographical location of each of the agent entities 300a:300K, device information of each of the agent entities 300a:300K, the amount of data locally obtainable by of each of the agent entities 300a:300K.

In some examples, the server entity 200 determines the reporting schedule to be dependent on the radio environment of the agent entities 300a:300K. The reporting schedule can for example be based on the device SSB index. The agent entities 300a:300K in user equipment 170a:170K served in a beam with a certain SSB index can then be configured to listen to the same set of time-frequency resources. In some examples, the server entity 200 determines the reporting schedule to be dependent on other methods that can be used to identify user equipment 170a:170K which are in the proximity of each other, e.g. location-based services positioning or ProSe Discovery procedures. The server entity 200 can thereby configure agent entities 300a:300K in user equipment 170a:170K in vicinity of each other to transmit and listen to the same set of time-frequency resources.

In some examples, the user equipment 170a:170K are configured to transmit uplink reference signals, such as sounding reference signals (SRSs), or uplink random access signalling and listen to such signals from other potential user equipment 170a:170K, thus ensuring that the radio links between the user equipment 170a:170K are of good quality. Agent entities 300a:300K in user equipment 170a:170K that can hear such signals from other user equipment 170a:170K might then be configured to transmit and listen to the same set of time-frequency resources.

In terms of device information of each of the agent entities 300a:300K, the agent entities 300a:300K might be configured to listen for reportings from agent entities 300a:300K provided in user equipment 170a:170K of a certain manufacturer, Original Equipment Manufacturer (OEM) vendor, device model, chipset vendor, chipset model, UE category (such as having a New Radio (NR) performance capability), UE class (such as enhanced Mobile Broadband (eMBB), Internet of Things (IoT), Ultra-Reliable Low-Latency Communication (URLLC), Extended Reality (XR)), etc.

In some examples, in case that one of the agent entities 300a:300K is expected to contribute largely to the overall model, the server entity 200 can configure a larger number of other agent entities 300a:300K to listen to reportings of the computational result from this one agent entity 300a:300K. The server entity 200 can configure the agent entities 300a:300K to, based on their estimated performances, transmit in time-frequency resources where more agent entities 300a:300K are listening The server entity 200 can configure the agent entities 300a:300K to increase their uplink power to improve hearability. The server entity 200 can configure the agent entities 300a:300K to change its beamforming pattern in order to increase the probability in transmitting energy in the direction towards other agent entities 300a:300K; the agent entities 300a:300K to can for example use an omni-directional transmission in comparison to a beam directed towards the server entity 200.

In some examples, the reporting of computational results from some or all of the agent entities 300a:300K is encrypted. This could be the case where information regarded as sensitive information, such as geolocation information. This requires agent entities 300a:300K that, according to the reporting schedule, are to overhear such a reporting to be able to decrypt the encrypted computational results. The server entity 200 might therefore configure these agent entities with keys for decrypting the encrypted computational results. Also homomorphic encryption techniques can be used, in order for a second agent entity to use the computational result from a first agent entity without first decrypting the computational result.

In some aspects, the agent entities 300a:300K are scheduled to weight any computational result received from any other agent entities 300a:300K. In particular, in some embodiments, according to the reporting schedule, the agent entities 300a:300K are configured to weight any computational result of the computational task received from any other of the agent entities 300a:300K with a weighting factor when computing their own computational result. The weight factors might be part of configuration provided by the server entity 200 to the agent entities 300a:300K.

In some aspects, the agent entities 300a:300K are to set a flag in the reporting when computational result is determined based on computational result from other agents 300a:300K. In particular, in some embodiments, according to the reporting schedule, the agent entities 300a:300K are configured to report their computational results with a flag set when their own computational results have been computed as a function of any computational result of the computational task received from any other of the agent entities 300a:300K. This could help the server entity 200 to distinguish reportings of computational results which are based on other computational results from computational results which are not based on other computational results.

In some aspects, the agent entities 300a:300K are to disregard data from certain other agents 300a:300K. In particular, in some embodiments, according to the reporting schedule, the agent entities 300a:300K are configured to disregard any computational result of the computational task received from at least one specified agent entity 300a:300K. This could enable the agent entities 300a:300K to disregard reportings of computational results from another agent entity that the server entity 200 suspects is not operating properly, or from an agent entity that is reporting outliers, or the like.

There may be different ways to perform the iterative learning process. In some embodiments, the server entity 200 is configured to perform (optional) actions S104a, S104b, S104c during each iteration of the iterative learning process (in action S104):

S104a: The server entity 200 provides a parameter vector of the computational task to the agent entities 300a:300K.

S104b: The server entity 200 obtains, according to the reporting schedule, computational results as a function of the parameter vector from the agent entities 300a:300K.

S104c: The server entity 200 updates the parameter vector as a function of an aggregate of the obtained computational results when the aggregate of the obtained computational results for the iteration fails to satisfy the termination criterion.

In accordance with the reporting schedule, the computational results from some of the agents 300a:300K are based on intermediate results from some of the other agents 300a:300K. That is, in some embodiments, the computational results are a function of the parameter vector for the iteration and of data locally obtained by the agent entity 300k, and the computational results from at least some of the agent entities 300a:300K are a function of computational result of the computational task received from any other agent entity 300a:300K for that iteration.

In some aspects, the server entity 200 updates the reporting schedule based on reportings of the computational results from the agent entities 300a:300K as well as statistics, and/or other types of feedback (for example, which computational results were received and used by which agent entity 300a:300K), received from the agent entities 300a:300K, etc. For example, the server entity 200 might, based on its received statistics, configure an updated set of time-frequency resources where each agent entity 300a:300K is to be listening (or not listening) for reportings of the computational results from other agent entities 300a:300K. Hence, in some embodiments, the server entity 200 is configured to perform (optional) action S104d:

S104d: The server entity 200 updates the reporting schedule for a next iteration of the iterative learning process based on the computational results received for a current iteration of the iterative learning process.

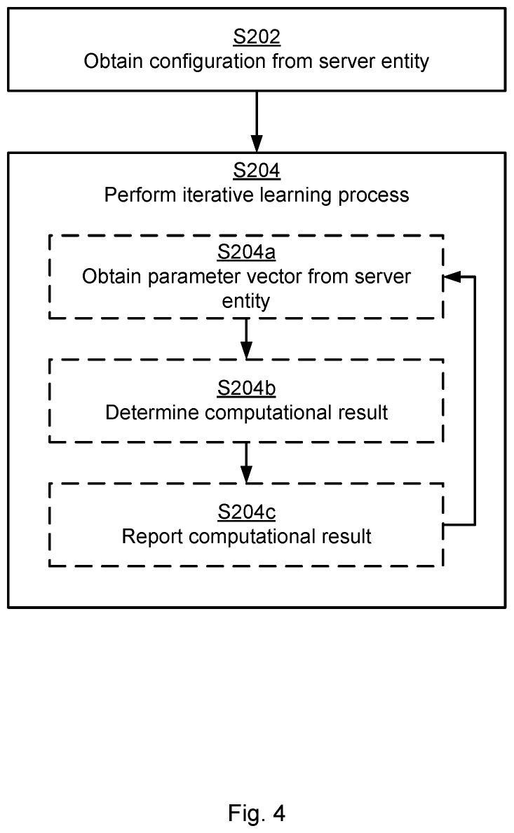

Reference is now made to FIG. 4 illustrating a method for an agent entity 300k to be configured by a server entity 200 with a reporting condition for reporting computational results during an iterative learning process as performed by the agent entity 300k according to an embodiment.

S202: The agent entity 300k obtains configuring in terms of a computational task and a reporting condition from the server entity 200. The reporting schedule defines an order according to which agent entities 300a:300K are to report computational results of the computational task. The agent entity 300k is configured to, per each iteration of the learning process, base its computation of the computational task on any computational result of the computational task received from any other agent entity 300k prior to when the agent entity 300k itself is scheduled to report its own computational result for that iteration

S204: The agent entity 300k performs the iterative learning process with the server entity 200 until a termination criterion is met. As part of the iterative learning process, the agent entity 300k reports a computational result for an iteration of the learning process according to the reporting schedule.

Embodiments relating to further details of being configured by a server entity 200 with a reporting condition for reporting computational results during an iterative learning process as performed by the agent entity 300k will now be disclosed.

As disclosed above, there may be different ways in which the reporting schedule can be represented. One way to represent the reporting schedule is in terms of time-frequency resources. In particular, in some embodiments, the some embodiments, the reporting schedule defines time-frequency resources in which the agent entity 300k is to report its own computational result. As further disclosed above, in some embodiments, the reporting schedule defines time-frequency resources in which the agent entity 300k is to receive any computational result of the computational task from any other of the agent entities 300a:300K.

As disclosed above, in some aspects, the agent entities 300a:300K are scheduled to weight any computational result received from any other agent entities 300a:300K. In particular, in some embodiments, according to the reporting schedule, the agent entity 300k is configured to weight any computational result of the computational task received from any other of the agent entities 300a:300K with a weighting factor when computing its own computational result.

As disclosed above, in some aspects, the agent entities 300a:300K are to set a flag in the reporting when computational result is determined based on computational result from other agents 300a:300K. In particular, in some embodiments, according to the reporting schedule, the agent entity 300k is configured to report its computational result with a flag set when its own computational result has been computed as a function of any computational result of the computational task received from any other of the agent entities 300a:300K.

As disclosed above, in some aspects, the agent entities 300a:300K are to disregard data from certain other agents 300a:300K. In particular, in some embodiments, according to the reporting schedule, the agent entity 300k is configured to disregard any computational result of the computational task received from at least one specified agent entity 300a:300K.

As disclosed above, there may be different ways to perform the iterative learning process. In some embodiments, the agent entity 300k is configured to perform (optional) actions S204a, S204b, S204c during each iteration of the iterative learning process (in action S204):

S204a: The agent entity 300k obtains a parameter vector of the computational problem from the server entity 200.

S204b: The agent entity 300k determines the computational result of the computational problem as a function of the obtained parameter vector for the iteration, of data locally obtained by the agent entity 300k, and of any computational result of the computational task received from any other agent entity 300k for that iteration.

S204c: The agent entity 300k reports the computational result for the iteration to the server entity 200 according to the reporting schedule.

As disclosed above, in accordance with the reporting schedule, the computational results from some of the agents 300a:300K are based on intermediate results from some of the other agents 300a:300K. That is, in some embodiments, the computational result of the computational task received from any other agent entity 300a:300K is by the agent entity 300k treated as an intermediate update of the parameter vector for that iteration.

As disclosed above with reference to FIG. 1, the server entity 200 might be provided in a network node 160, and each of the agent entities 300a:300K might be provided in a respective user equipment 170a:170K. Further aspects relating to communication between the server entity 200 and the agent entities 300a:300K in this case will now be disclosed.

The network node 160 might be configured to, on behalf of the server entity 200, configure the time-frequency resources in which each of the agent entities 300a:300K is to report its own computational result and the time-frequency resources in which each of the agent entities 300a:300K is to receive any computational result of the computational task from any other of the agent entities 300a:300K. In some examples, the time-frequency resources are associated to a certain radiolocation (such as the device serving SSB). In some examples, the network node 160 is configured to configure the user equipment 170a:170K with beamforming settings the user equipment 170a:170K are to use when, on behalf of the agent entities 300a:300K, reporting the computational result to the server entity 200.

The network node 160 might be configured to, on behalf of the server entity 200, transmit, using broadcast, multicast, or unicast signalling, the computational task and the reporting schedule.

The network node 160 might be configured to, on behalf of the server entity 200, receive the computational results from the agent entities 300a:300K.

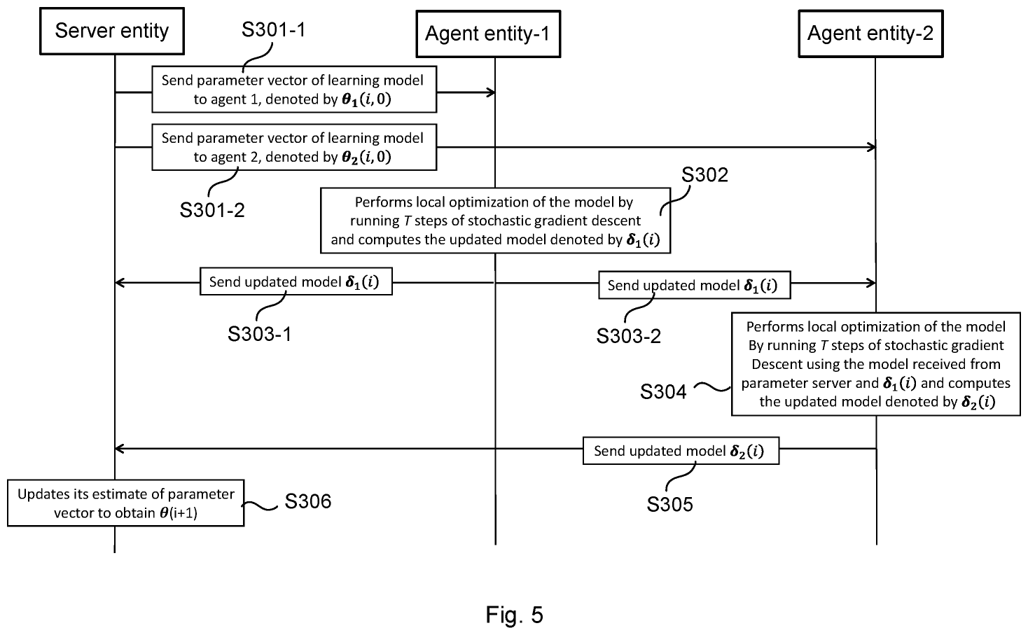

One particular embodiment for the server entity 200 to configuring agent entities 300a:300K with a reporting schedule for reporting computational results during an iterative learning process and for the agent entity 300k to be configured by the server entity 200 with the reporting condition for reporting computational results during the iterative learning process based on at least some of the above disclosed embodiments will now be disclosed in detail with reference to the signalling diagram of FIG. 5.

For simplification of notation but without loss of generality, it is assumed that there are two agent entities, denoted agent entity-1 and agent entity-2, respectively. Assume that, according to the reporting schedule, agent entity-2 is to base its computation of the computational result of the computational task on a computational result of the computational task as received from agent entity-1. In step S301-1 server entity 200 sends parameter vector θ₁(i, 0) to agent entity-1. In step S301-2 server entity 200 sends parameter vector θ₂(i, 0) to agent entity-2. In step S302 agent entity-1 calculates δ₁(i). Assume that, according to the reporting schedule, agent entity-1 transmits its update δ₁(i) first (step S303) and that agent entity-2 can overhear (step S303-2) and decode this transmission. Then, instead of basing its update solely on the parameter vector as received from the server entity 200, agent entity-2 can base its update on the parameter vector as well as the update δ₁(i) agent entity-2 overheard from agent entity-1 (step S304). More specifically, instead of the local iteration update (where k=2)

$${θ}_{k} ( i , τ ) = {θ}_{k} ( i , τ - 1 ) - {η}_{k} ∇ {f}_{k} ( {θ}_{k} ( i , τ - 1 ) ) \qquad τ = 1 , … , T ,$$

that agent entity-2 would nominally use, agent entity-2 computes the update:

$${θ}_{2} ( i , 0 ) = {θ}_{2} ( i , τ - 1 ) - η ∇ {f}_{2} ( {θ}_{2} ( i , τ - 1 ) + w {δ}_{1} ( i ) )$$

where w and η are weights, and then agent entity-2 computes:

$${δ}_{2} ( i ) = {θ}_{2} ( i , T ) - {θ}_{k} ( i , 0 )$$

Agent entity-2 then transmits its update δ₂(i) to server entity 200. The server entity 200 updates (step S306) its estimate of the parameter vector θ(i) by adding to it a linear combination (such as a weighted sum) of the updates received from all the agent entities;

$$θ ( i + 1 ) = θ ( i ) + {w}_{1} {δ}_{1} ( i ) + {w}_{2} {δ}_{2} ( i )$$

where w₁ and w₂ are weights.

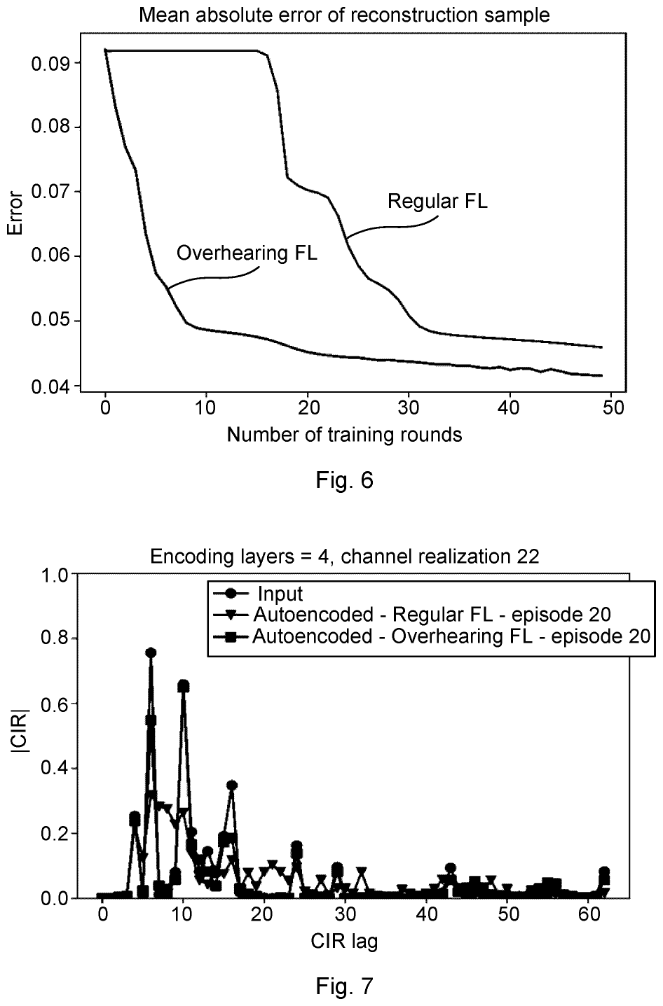

Simulation results will be presented next with reference to FIG. 6 and FIG. 7.

FIG. 6 shows simulation results for an example scenario with four agent entities, each provided in a respective user equipment. According to the reporting schedule, during each iteration of the iterative learning process, one agent entity reports a computational result that is overheard by the other three agent entities. These three agent entities use the overheard computational result when computing their own computational result. The server entity 200 then aggregates the computational results received from all the four agent entities. In FIG. 6 is shown the resulting training loss together with the training loss for regular non-overhead model training. The results illustrate how the herein disclosed embodiments can improve the training convergence of the iterative learning process.

FIG. 7 shows simulation results where the computational task pertains to compressing channel-state-information using an auto-encoder. The aim is to reconstruct input defining a time-domain normalized absolute channel impulse response. Results are shown after 20 iterations of the iterative learning process. A comparison is made to a regular non-overhead iterative learning process. The normalized absolute channel impulse response is also shown for the 20 iterations. The results indicate how the herein disclosed embodiments provides improvements in reconstructing the time-domain normalized absolute channel impulse response.

Illustrative examples where the herein disclosed embodiments apply will now be disclosed.

According to a first example, the computational task pertains to prediction of best secondary carrier frequencies to be used by user equipment 170a:170K in which the agent entities 300a:300K are provided. The data locally obtained by the agent entity 300k can then represent a measurement on a serving carrier of the user equipment 170k. In this respect, the best secondary carrier frequencies for user equipment 170a:170K can be predicted based on their measurement reports on the serving carrier. The secondary carrier frequencies as reported thus defines the computational result. In order to enable such a mechanism, the agent entities 300a:300K can be trained by the server entity 200, where each agent entity 300k takes as input the measurement reports on the serving carrier(s) (among possibly other available reports such as timing advance, etc.) and as outputs a prediction of whether the user equipment 170k in which the agent entity 300k is provided has coverage or not in the secondary carrier frequency. The herein disclosed embodiments can be applied to enable at least some of the agent entities 300a:300K to base their own computation of the best secondary carrier frequencies on any reporting of the best secondary carrier frequencies as received from any other agent entity 300a:300K.

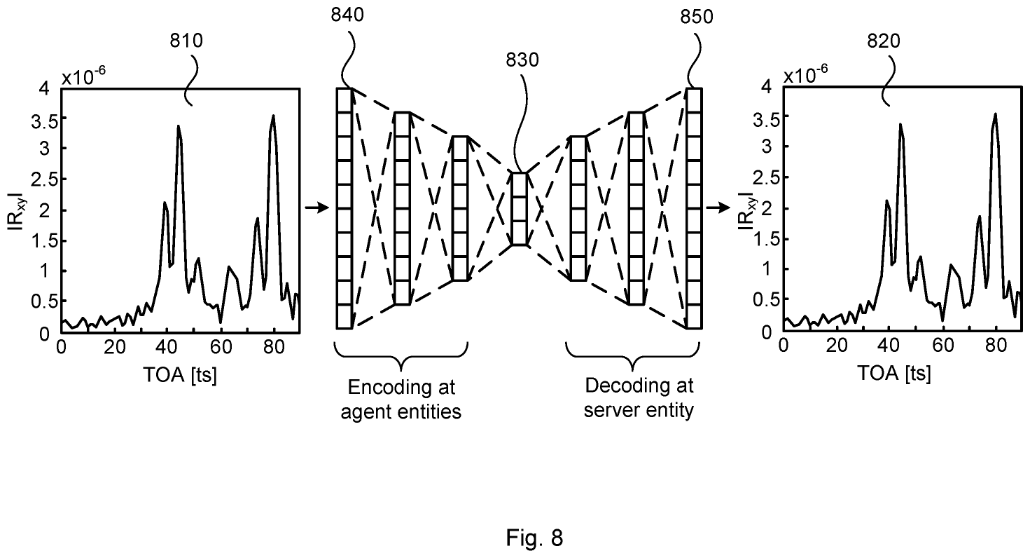

According to a second example, the computational task pertains to compressing channel-state-information using an auto-encoder, where the server entity 200 implements a decoder of the auto-encoder, and where each of the agent entities 300a:300K implements a respective encoder of the auto-encoder. An autoencoder can be regarded as a type of neural network used to learn efficient data representations (denoted by code hereafter). One example of an autoencoder comprising an encoder/decoder for CSI compression is shown in the block diagram of FIG. 8. In this example, the absolute values of the Channel Impulse Response (CIR), as represented by input 840, are, at the agent entities 300a:300K, compressed to a code 830, and then the resulting code is, at the server entity 200, decoded to reconstruct the measured CIR, as represented by output 850. The reconstructed CIR 820 is almost identical to the original CIR 810. The CIR 810, 820 is plotted in terms of the magnitude of the cross-correlation |R_{xy}| between a transmit signal and a receive signal as a function of time of arrival (TOA) in units of the physical layer time unit Ts, where 1 Ts= 1/30720000 seconds. In practice, instead of transmitting raw CIR values from the user equipment 170a:170K to the network node 160, the agent entities 300a:300K thus encode the raw CIR values using the encoders and report the resulting code to the server entity 200. The code as reported thus defines the computational result. The server entity 200, upon reception of the code from the agent entities 300a:300K, reconstructs the CIR values using the decoder. Since the code can be sent with fewer information bits, this will result in significant signaling overhead reduction. The reconstruction accuracy can be further enhanced if as many independent agent entities 300a:300K as possible are utilized. This can be achieved by enabling each agent entity 300k to contribute to training a global model preserved at the server entity 200. The herein disclosed embodiments can be applied to enable at least some of the agent entities 300a:300K to base their own computation of the code on any reporting of the code as received from any other agent entity 300a:300K.

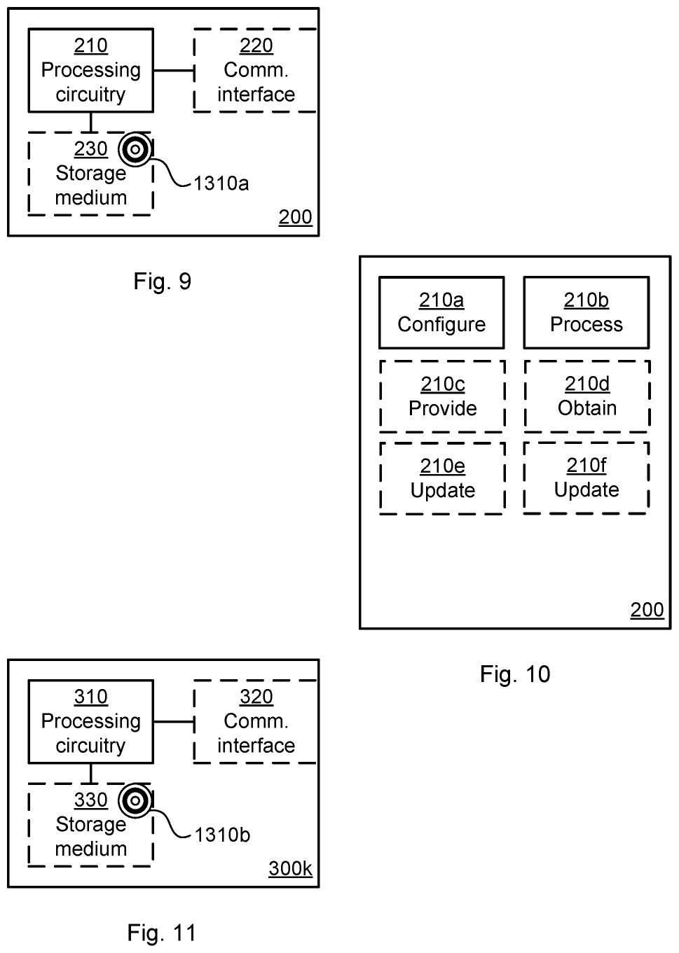

FIG. 9 schematically illustrates, in terms of a number of functional units, the components of a server entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310a (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the server entity 200 to perform a set of operations, or steps, as disclosed above. For example, the storage medium 230 may store the set of operations, and the processing circuitry 210 may be configured to retrieve the set of operations from the storage medium 230 to cause the server entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The server entity 200 may further comprise a communications interface 220 for communications with other entities, functions, nodes, and devices, either directly or indirectly. As such the communications interface 220 may comprise one or more transmitters and receivers, comprising analogue and digital components.

The processing circuitry 210 controls the general operation of the server entity 200 e.g. by sending data and control signals to the communications interface 220 and the storage medium 230, by receiving data and reports from the communications interface 220, and by retrieving data and instructions from the storage medium 230. Other components, as well as the related functionality, of the server entity 200 are omitted in order not to obscure the concepts presented herein.

FIG. 10 schematically illustrates, in terms of a number of functional modules, the components of a server entity 200 according to an embodiment. The server entity 200 of FIG. 10 comprises a number of functional modules; a configure module 210a configured to perform step S102, and a process module 210b configured to perform step S104. The server entity 200 of FIG. 10 may further comprise a number of optional functional modules, such as any of a provide module 210c configured to perform step S104a, an obtain module 210d configured to perform step S104b, an update module 210e configured to perform step S104c, and an update module 210f configured to perform step S104d. In general terms, each functional module 210a:210f may be implemented in hardware or in software. Preferably, one or more or all functional modules 210a:210f may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210f and to execute these instructions, thereby performing any steps of the server entity 200 as disclosed herein.

The server entity 200 may be provided as a standalone device or as a part of at least one further device. Thus, a first portion of the instructions performed by the server entity 200 may be executed in a first device, and a second portion of the instructions performed by the server entity 200 may be executed in a second device; the herein disclosed embodiments are not limited to any particular number of devices on which the instructions performed by the server entity 200 may be executed. Hence, the methods according to the herein disclosed embodiments are suitable to be performed by a server entity 200 residing in a cloud computational environment. Therefore, although a single processing circuitry 210 is illustrated in FIG. 9 the processing circuitry 210 may be distributed among a plurality of devices, or nodes. The same applies to the functional module 210a:210f of FIG. 10 and the computer program 1320a of FIG. 13.

FIG. 11 schematically illustrates, in terms of a number of functional units, the components of an agent entity 300k according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1310b (as in FIG. 13), e.g. in the form of a storage medium 330. The processing circuitry 310 may further be provided as at least one application specific integrated circuit (ASIC), or field programmable gate array (FPGA).

Particularly, the processing circuitry 310 is configured to cause the agent entity 300k to perform a set of operations, or steps, as disclosed above. For example, the storage medium 330 may store the set of operations, and the processing circuitry 310 may be configured to retrieve the set of operations from the storage medium 330 to cause the agent entity 300k to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The agent entity 300k may further comprise a communications interface 320 for communications with other entities, functions, nodes, and devices, either directly or indirectly. As such the communications interface 320 may comprise one or more transmitters and receivers, comprising analogue and digital components.

The processing circuitry 310 controls the general operation of the agent entity 300k e.g. by sending data and control signals to the communications interface 320 and the storage medium 330, by receiving data and reports from the communications interface 320, and by retrieving data and instructions from the storage medium 330. Other components, as well as the related functionality, of the agent entity 300k are omitted in order not to obscure the concepts presented herein.

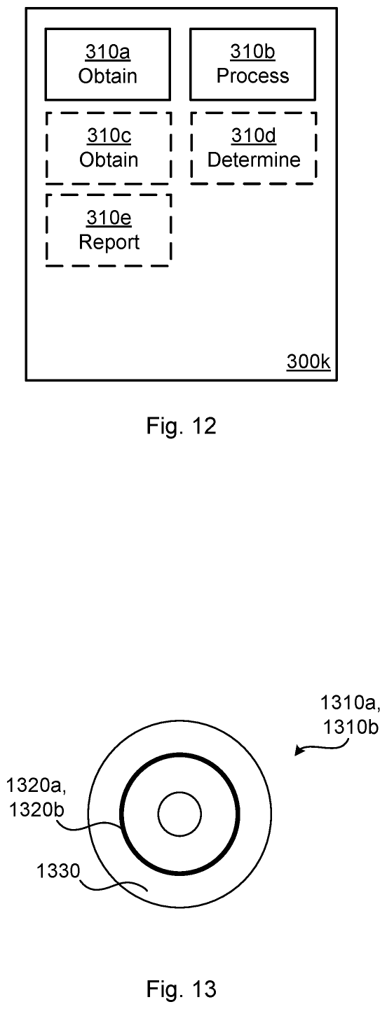

FIG. 12 schematically illustrates, in terms of a number of functional modules, the components of an agent entity 300k according to an embodiment. The agent entity 300k of FIG. 12 comprises a number of functional modules; an obtain module 310a configured to perform step S202, and a process module 310b configured to perform step S204. The agent entity 300k of FIG. 12 may further comprise a number of optional functional modules, such as any of an obtain module 310c configured to perform step S104a, a determine module 310d configured to perform step S104b, and a report module 310e configured to perform step S104c. In general terms, each functional module 310a:310e may be implemented in hardware or in software. Preferably, one or more or all functional modules 310a:310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310e and to execute these instructions, thereby performing any steps of the agent entity 300k as disclosed herein.

The agent entity 300k may be provided as a standalone device or as a part of at least one further device. Thus, a first portion of the instructions performed by the agent entity 300k may be executed in a first device, and a second portion of the instructions performed by the agent entity 300k may be executed in a second device; the herein disclosed embodiments are not limited to any particular number of devices on which the instructions performed by the agent entity 300k may be executed. Hence, the methods according to the herein disclosed embodiments are suitable to be performed by an agent entity 300k residing in a cloud computational environment. Therefore, although a single processing circuitry 310 is illustrated in FIG. 11 the processing circuitry 310 may be distributed among a plurality of devices, or nodes. The same applies to the functional module 310a:310e of FIG. 12 and the computer program 1320b of FIG. 13.

FIG. 13 shows one example of a computer program product 1310a, 1310b comprising computer readable means 1330. On this computer readable means 1330, a computer program 1320a can be stored, which computer program 1320a can cause the processing circuitry 210 and thereto operatively coupled entities and devices, such as the communications interface 220 and the storage medium 230, to execute methods according to embodiments described herein. The computer program 1320a and/or computer program product 1310a may thus provide means for performing any steps of the server entity 200 as herein disclosed. On this computer readable means 1330, a computer program 1320b can be stored, which computer program 1320b can cause the processing circuitry 310 and thereto operatively coupled entities and devices, such as the communications interface 320 and the storage medium 330, to execute methods according to embodiments described herein. The computer program 1320b and/or computer program product 1310b may thus provide means for performing any steps of the agent entity 300k as herein disclosed.

In the example of FIG. 13, the computer program product 1310a, 1310b is illustrated as an optical disc, such as a CD (compact disc) or a DVD (digital versatile disc) or a Blu-Ray disc. The computer program product 1310a, 1310b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320a, 1320b is here schematically shown as a track on the depicted optical disk, the computer program 1320a, 1320b can be stored in any way which is suitable for the computer program product 1310a, 1310b.

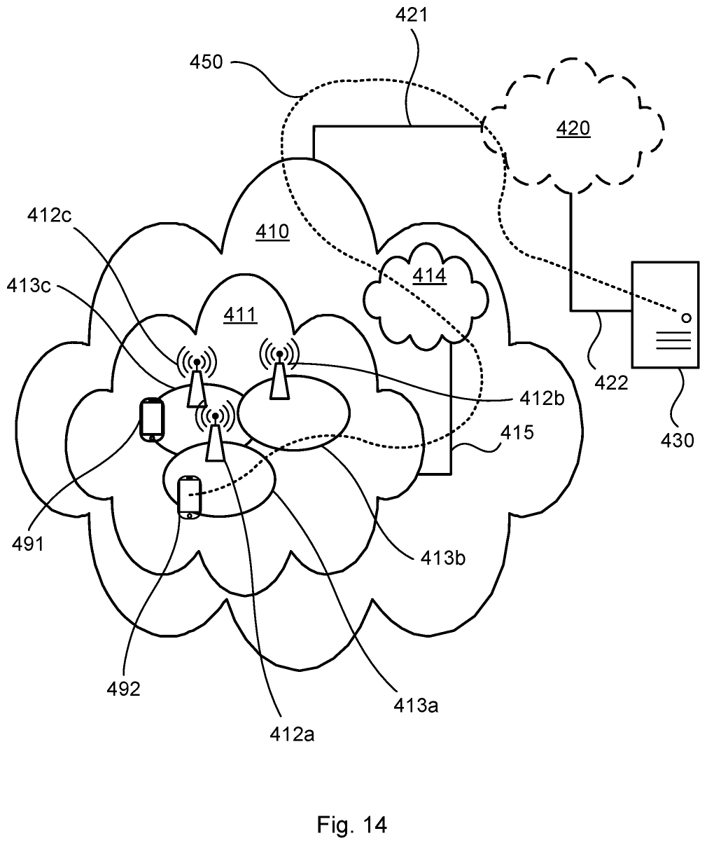

FIG. 14 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 160 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the UEs 170a:170K of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 14 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

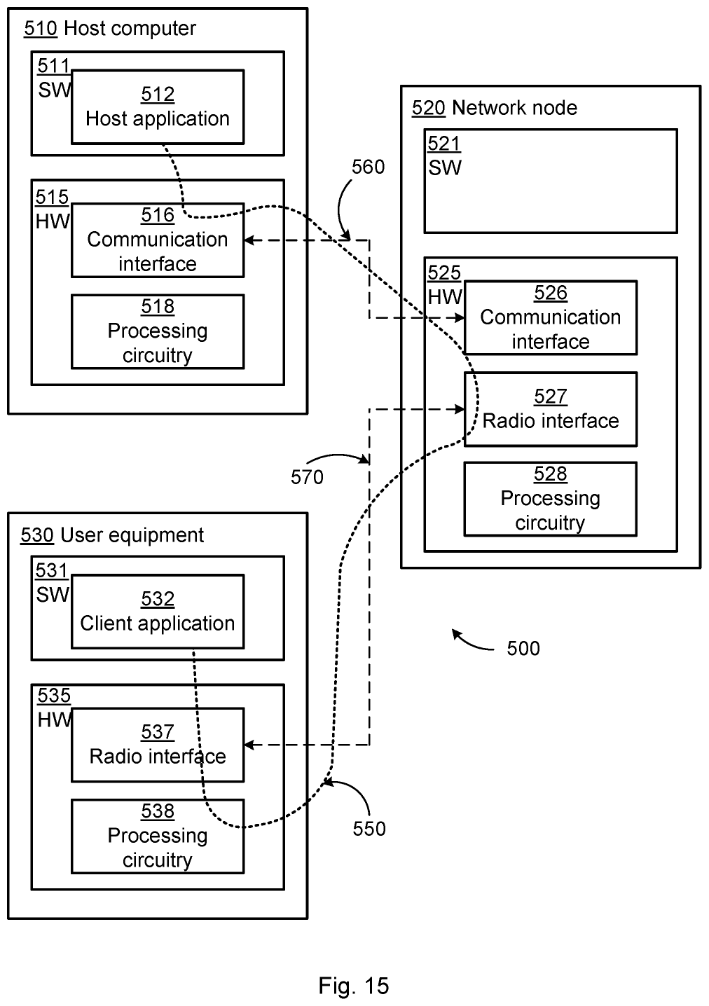

FIG. 15 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 15. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the UEs 170a:170K of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 160 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 15) served by radio access network node 520. Communication interface 526 may be configured to facilitate connection 560 to host computer 510. Connection 560 may be direct or it may pass through a core network (not shown in FIG. 15) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 15 may be similar or identical to host computer 430, one of network nodes 412a, 412b, 412c and one of UEs 491, 492 of FIG. 14, respectively. This is to say, the inner workings of these entities may be as shown in FIG. 15 and independently, the surrounding network topology may be that of FIG. 14.

In FIG. 15, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for configuring agent entities with a reporting schedule for reporting computational results during an iterative learning process, the method being performed by a server entity, the method comprising:
configuring the agent entities with a computational task and a reporting schedule, wherein the reporting schedule defines an order according to which the agent entities are to report computational results of the computational task, and wherein the agent entities are configured to, per each iteration of the learning process, base their computation of the computational task on any computational result of the computational task received from any other of the agent entities prior to when the agent entities themselves are scheduled to report their own computational results for that iteration; and
performing the iterative learning process with the agent entities according to the reporting schedule and until a termination criterion is met.

2. The method according to claim 1, wherein the reporting schedule defines time-frequency resources in which each of the agent entities is to report its own computational result.

3. The method according to claim 1, wherein the reporting schedule defines time-frequency resources in which each of the agent entities is to receive any computational result of the computational task from any other of the agent entities.

4. The method according to claim 1, wherein, according to the reporting schedule, the agent entities are configured to one at a time in a sequential order report their computational results of the computational task.

5. The method according to claim 4, wherein the sequential order is dependent on at least one of:
channel quality between the server entity and each of the agent entities,
channel quality between the agent entities themselves,
geographical location of each of the agent entities,
device information of each of the agent entities,
device capability of each of the agent entities,
amount of data locally obtainable by of each of the agent entities.

6. The method according to claim 1, wherein whether or not the agent entities are to be configured to base their computation of the computational task on any computational result of the computational task received from any other of the agent entities is dependent on at least one of:
channel quality between the agent entities themselves,
geographical location of each of the agent entities,
device information of each of the agent entities,
amount of data locally obtainable by of each of the agent entities.

7. The method according to claim 1, wherein, according to the reporting schedule, the agent entities are configured to weight said any computational result of the computational task received from any other of the agent entities with a weighting factor when computing their own computational result.

8. The method according to claim 1, wherein, according to the reporting schedule, the agent entities are configured to report their computational results with a flag set when their own computational results have been computed as a function of said any computational result of the computational task received from any other of the agent entities.

9. The method according to claim 1, wherein, according to the reporting schedule, the agent entities are configured to disregard any computational result of the computational task received from at least one specified agent entity.

10. The method according to claim 1, wherein the server entity during each iteration of the iterative learning process:
provides a parameter vector of the computational problem to the agent entities;
obtains, according to the reporting schedule, computational results as a function of the parameter vector from the agent entities; and
updates the parameter vector as a function of an aggregate of the obtained computational results when the aggregate of the obtained computational results for the iteration fails to satisfy the termination criterion.

11. The method according to claim 10, wherein the computational results are a function of the parameter vector for the iteration and of data locally obtained by the agent entity, and wherein the computational results from at least some of the agent entities are a function of computational result of the computational task received from any other agent entity for that iteration.

12. The method according to claim 1, wherein the method further comprises:
updating the reporting schedule for a next iteration of the iterative learning process based on the computational results received for a current iteration of the iterative learning process.

13. The method according to claim 1, wherein the computational task pertains to prediction of best secondary carrier frequencies based on measurements on a first carrier frequency to be used by user equipment in which the agent entities are provided.

14. The method according to claim 1, wherein the computational task pertains to compressing channel-state-information using an auto-encoder, wherein the server entity implements a decoder of the auto-encoder, and wherein each of the agent entities implements a respective encoder of the auto-encoder.

15. The method according to claim 1, wherein the server entity is provided in a network node, and each of the agent entities is provided in a respective user equipment.

16. A method for being configured by a server entity with a reporting condition for reporting computational results during an iterative learning process, the method being performed by an agent entity, the method comprising:
obtaining configuring in terms of a computational task and a reporting condition from the server entity, wherein the reporting schedule defines an order according to which agent entities are to report computational results of the computational task, and wherein the agent entity is configured to, per each iteration of the learning process, base its computation of the computational task on any computational result of the computational task received from any other agent entity prior to when the agent entity itself is scheduled to report its own computational result for that iteration; and
performing the iterative learning process with the server entity until a termination criterion is met, wherein, as part of the iterative learning process, the agent entity reports a computational result for an iteration of the learning process according to the reporting schedule.

17. The method according to claim 16, wherein the reporting schedule defines time-frequency resources in which the agent entity is to report its own computational result.

18. The method according to claim 16, wherein the reporting schedule defines time-frequency resources in which the agent entity is to receive any computational result of the computational task from any other of the agent entities.

19. The method according to claim 16, wherein, according to the reporting schedule, the agent entity is configured to weight said any computational result of the computational task received from any other of the agent entities with a weighting factor when computing its own computational result.

20. The method according to claim 16, wherein, according to the reporting schedule, the agent entity is configured to report its computational result with a flag set when its own computational result has been computed as a function of said any computational result of the computational task received from any other of the agent entities.

21-36. (canceled)
